(19) United States
(12) Patent Application Publication
(10) Pub. No.: US 2015/0323188 A1
(43) Pub. Date: Nov. 12, 2015

(54) ENCLOSED GAS FUEL DELIVERY SYSTEM

(71) Applicant: SOLAR TURBINES INCORPORATED, San Diego, CA (US)

(72) Inventors: Elona Rista, San Diego, CA (US); Peter J. Baron, San Diego, CA (US)

(73) Assignee: SOLAR TURBINES INCORPORATED, San Diego, CA (US)

(21) Appl. No.: 14/270,582

(22) Filed: May 6, 2014

(51) Int. Cl. F23R 3/36; B63H 21/16; B63H 21/38; F02C 7/00; F02C 9/40

(52) U.S. Cl. CPC F23R 3/36; F02C 7/00; F02C 9/40; B63H 21/38; B63H 21/16; F23R 2900/00; B63B 2770/00

(57) ABSTRACT

A gas fuel delivery system is disclosed. A gas fuel delivery system includes a gas fuel system and a gas ring. The gas fuel delivery system includes an enclosure surrounding the gas fuel system. The enclosure includes a ventilation system. The enclosure includes fuel pipes connecting the gas fuel system to a fuel source and to a gas ring. Each fuel pipe includes an outer conduit and an inner conduit, wherein the inner conduit is enclosed by the outer conduit. The inner conduit is in fluid communication with the gas fuel system.

### TECHNICAL FIELD

The present disclosure generally pertains to gas turbine engines, and is directed toward an enclosed gas fuel delivery system.

### BACKGROUND

Gas turbine engine packages typically include certain support systems, such as a gas fuel system, that are installed on or within an enclosure encompassing the entire gas turbine engine package. Gas fuel systems may be located separately in their own enclosures and connected to the rest of a gas turbine engine system. Such gas turbine engine systems may be found in carriers, such as vessels, and may combust natural gas, diesel, or other types of liquid or gaseous fuel.

European Patent Publication No. 2503128 to V. Oevelen, et al., discloses a fuel supply system for boats fuelled by alternative fuels. The system comprises at least one pressure regulator which receives the fuel at a supply pressure and delivers it at a delivery pressure, different from the supply pressure, to injection and/or solenoid valve devices which supply the motor with fuel. The system comprises at least one closed container which includes an inner volume containing said pressure regulator and, at least partially, said supply and delivery devices. The closed container is hermetically tight sealed to the gaseous fuel and comprises at least one vent in fluidic communication with the inner volume of the container. The vent fluidly connects the inner volume with the environment outside the system so as to channel any fuel leaks towards the outside of the boat.

The present disclosure is directed toward overcoming one or more of the problems discovered by the inventors.

### SUMMARY OF THE DISCLOSURE

A gas fuel delivery system is disclosed. The gas fuel delivery system includes a gas fuel system and a gas ring. The gas fuel delivery system also includes an enclosure surrounding the gas fuel system. The enclosure includes a ventilation system. The gas fuel delivery system further includes an engine fuel pipe connecting the gas fuel system to the gas ring. The engine fuel pipe includes a first fuel conduit and a first containment vessel. The first containment vessel encloses the first fuel conduit. The first fuel conduit is in fluid communication with the gas fuel system and the gas ring. The gas fuel delivery system includes a source fuel pipe connected to the gas fuel system. The source fuel pipe includes a second fuel conduit and a second containment vessel. The second containment vessel encloses the second fuel conduit. The second fuel conduit is in fluid communication with the gas fuel system.

### BRIEF DESCRIPTION OF THE DRAWINGS

FIG. 1 is a side view of a vessel with a gas fuel delivery system.

FIG. 2 is a back view of a vessel with a gas fuel delivery system.

FIG. 3 is a schematic illustration of an exemplary gas turbine engine with a gas fuel delivery system.

FIG. 4 is a schematic illustration of a gas fuel delivery system.

### DETAILED DESCRIPTION

A gas fuel delivery system is disclosed. The gas fuel delivery system includes a gas fuel system and a gas ring. The gas fuel delivery system also includes an enclosure surrounding the gas fuel system. Dual walled fuel pipes may be connected to the gas fuel system and to the gas ring. Components of the dual walled fuel pipes may be in fluid communication with the gas fuel system. The gas fuel delivery system may be used in a vessel powered by a gas turbine engine. In some embodiments, a vessel may have more than one gas turbine engine, each engine connected to a separate fuel delivery system. The enclosure may include a number of cautionary/safety mechanisms in case of a gas leak within the dual walled fuel pipe. Furthermore, the enclosure may occupy a smaller geometric footprint as well as reduce weight compared to traditional enclosures belonging to traditional gas turbine engine systems. This may aid in increasing the thrust produced by the gas turbine engine(s).

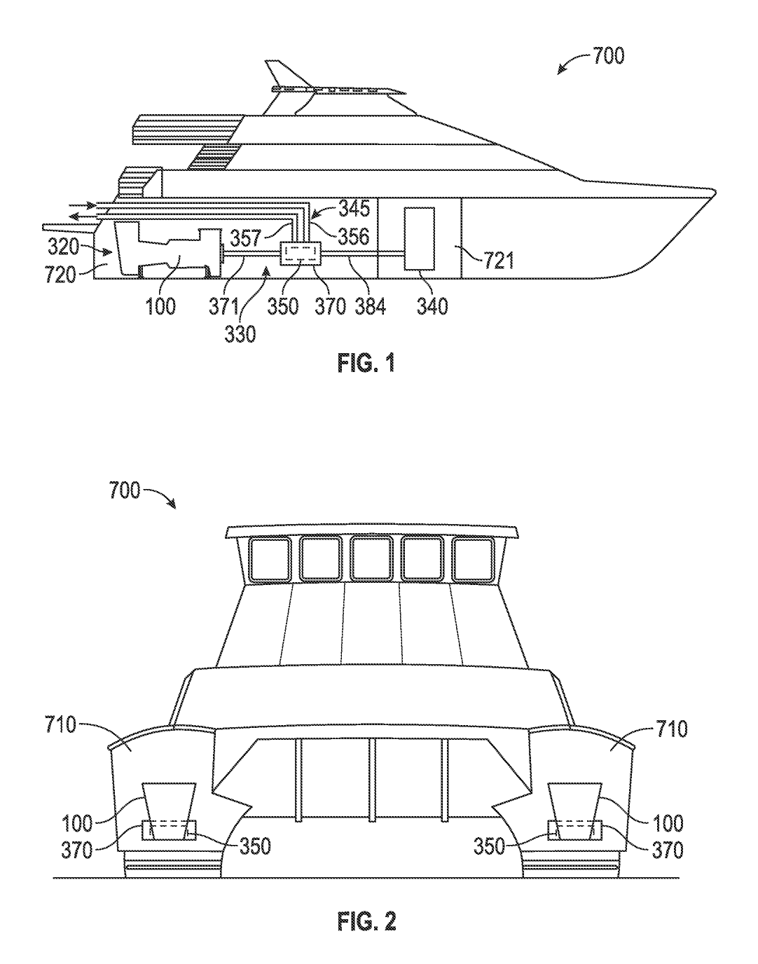

FIG. 1 depicts a side view, shown schematically, of a vessel 700 with a gas turbine engine system 320. Certain structural elements of vessel 700 may not be shown for clarity of illustration. Vessel 700 may be a marine ship such as a catamaran or a trimaran. In other embodiments, vessel 700 may be a locomotive or a truck, or some other transportation vehicle. Gas turbine engine system 320 may include a gas turbine engine 100 and a gas fuel delivery system 330 (sometimes referred to as enclosed gas fuel delivery system). The gas fuel delivery system 330 may include a gas turbine engine 100 with a gas fuel system 350. Gas turbine engine 100 and gas fuel system 350 may be located within an engine room 720 of the vessel 700. Furthermore, gas fuel system 350 may also be connected to a fuel tank 340 which may be located in a fuel room 721. A source fuel pipe 384 may connect fuel tank 340 to gas fuel system 350. A fuel pipe 371, or herein may be referred to as engine fuel pipe 371, may connect gas fuel system 350 to gas turbine engine 100. Gas fuel system 350 may be a dual fuel system configured to combust gas fuels or liquid fuels. For example, gas fuel, such as natural gas, or liquid fuel, such as diesel, may be pumped from fuel tank 340 to gas fuel system 350.

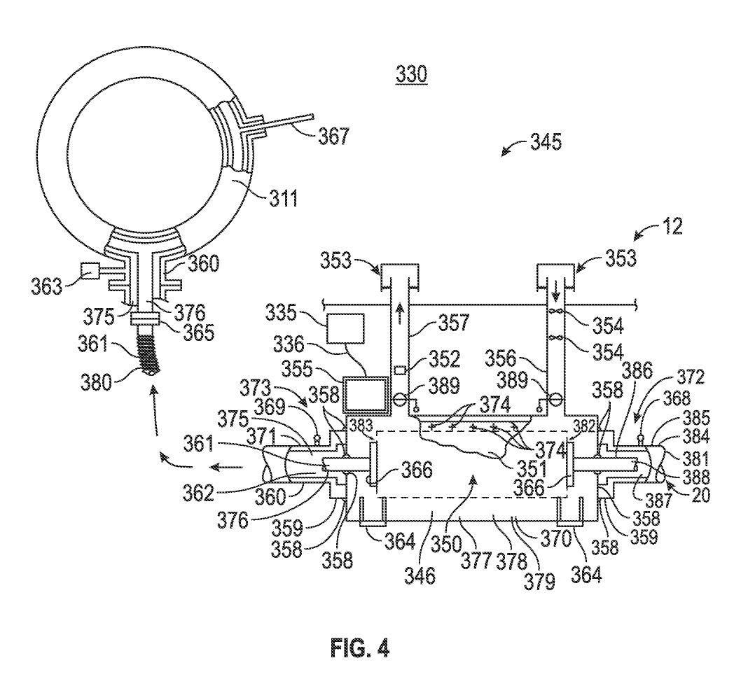

In a preferred embodiment, gas fuel system 350 is surrounded by an enclosure 370. As will be explained below, enclosure 370 may include multiple systems such as a ventilation system 345, a fire suppression system 378 (shown in FIG. 4), a gas detection system 379 (shown in FIG. 4), and a gas processing system 377 (shown in FIG. 4). Ventilation system 345 may include an air inlet 356 and an air outlet 357 to an atmosphere outside of vessel 700. In some embodiments, certain systems, such as fire suppression system, may not be located within enclosure 370 and instead be installed in engine room 720. Other systems may also be consolidated either in enclosure 370 or in the engine room 720, fuel room 721, or other compartments of vessel 700. Sound insulation may also be installed into the walls of engine room 720.

FIG. 2 depicts a back view, shown schematically, of a vessel 700 with a gas fuel system 350 connected to a gas turbine engine 100. Vessel 700 may be a catamaran, which may include two hulls 710. As shown, gas fuel system 350 may be located behind gas turbine engine 100. Gas fuel system 350 may be enclosed by enclosure 370. Certain components of gas fuel delivery system 330 are not shown for clarity of illustration, as well as certain structural elements of vessel 700. In some embodiments, the size of the hull 710 on each side of vessel 700 may be a limiting factor for the installation of gas fuel system 350 and gas turbine engine 100.

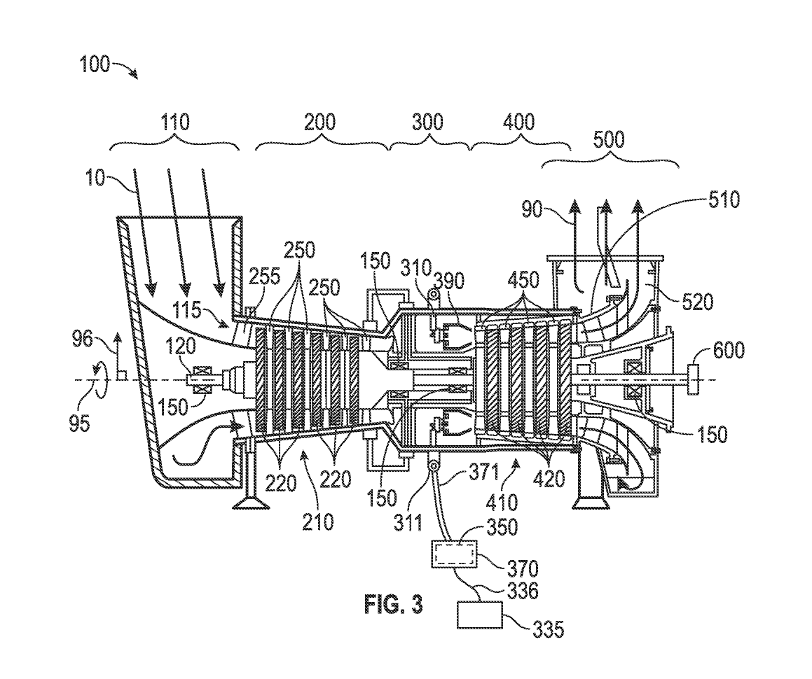

FIG. 3 is a schematic illustration of an exemplary gas turbine engine. The gas turbine engine 100 may be connected to a gas fuel system 350 surrounded by an enclosure 370. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a shaft 120, a gas producer or compressor 200, a combustor 300, a turbine 400, an exhaust 500, and a power output coupling 600. The gas turbine engine 100 may have a single shaft or a dual shaft configuration.

The compressor 200 includes a compressor rotor assembly 210, compressor guide vanes (sometimes referred to as stators or stationary vanes) 250, and inlet guide vanes 255. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Guide vanes 250 axially follow each of the compressor disk assemblies 220. Each compressor disk assembly 220 paired with the adjacent guide vanes 250 that follow the compressor disk assembly 220 is considered a compressor stage. Compressor 200 includes multiple compressor stages. In some embodiments, guide vanes 250 within the first few compressor stages are variable guide vanes.

The combustor 300 includes one or more injectors 310 and includes one or more combustion chambers 390. Fuel may be supplied to combustor 300 by a gas fuel system 350. Gas fuel system 350 may be enclosed by an enclosure 370, and may be connected to a gas turbine control system 335 by an electrical wiring harness 336. Gas fuel system 350 may be connected to a gas ring 311 by a fuel pipe 371. Gas ring 311 may be connected to injectors 310 and may direct fuel to the one or more injectors 310.

The turbine 400 includes a turbine rotor assembly 410, turbine disk assemblies 420, and turbine nozzles 450.

FIG. 4 depicts a schematic illustration of a gas fuel delivery system 330. Gas fuel delivery system 330 may include a gas fuel system 350, an enclosure 370, an engine fuel pipe (or fuel pipe) 371, a source fuel pipe 384, an electric terminal box 355, a gas ring 311, a gas turbine control system 335, and various connectors, valves, and pipes. In general, gas fuel system 350 can be a system of pumps, valves, and piping for delivering fuel to the combustion chamber. Piping in the gas fuel delivery system 330, such as engine fuel pipe 371 and source fuel pipe 384, may be cylindrical or tubular piping for transporting fluids. Gas fuel system 350 may regulate pressure of the fuel through the system. By doing so, gas fuel system 350 may control the flow rate of the fuel pumped into a combustion chamber of a connected gas turbine engine to adjust power or thrust of the engine. Gas fuel system 350 may control the flow rate either automatically or manually. In some embodiments, the fuel flow rate may be controlled by gas turbine control system 335. Gas turbine control system 335 may include all of the functional processes that permit an operator to start/stop and increase/decrease the speed of the gas turbine engine. Gas turbine control system may also control supporting systems such as fuel and lubrication systems.

Engine fuel pipe 371 may connect gas fuel system 350 to gas ring 311. This connection may be at a first connection 380. In some instances, engine fuel pipe 371 may connect gas fuel system 350 to gas ring 311 by a pipe connector 365. Source fuel pipe 384 may connect gas fuel system 350 to a fuel source. This connection may be at a second connection 381. Fuel within gas ring 311 may be directed about gas ring 311 by a plurality of injector leads 367. The injector leads may be connected to injectors which inject the fuel into the combustion chamber as an atomized spray. Injectors may include a fuel spray nozzle to atomize the fuel.

In general, engine fuel pipe 371 and source fuel pipe 384 may each include a fuel conduit enclosed by a containment vessel. For example, engine fuel pipe 371 may include a first fuel conduit, such as engine fuel pipe inner wall 361, enclosed by a first containment vessel, such as engine fuel pipe outer wall 360. The first containment vessel may enclose the first fuel conduit and may form a first outer conduit, such as engine fuel pipe outer channel 375 there between. Similarly, source fuel pipe 384 may include a second fuel conduit, such as source fuel pipe inner wall 386, enclosed by a second containment vessel, such as source fuel pipe outer wall 385. The second containment vessel may enclose the second fuel conduit and may form a second outer conduit, such as source fuel pipe outer channel 387, there between.

In some embodiments, engine fuel pipe 371 and source fuel pipe 384 may be dual walled pipe assemblies. Engine fuel pipe 371 may include an engine fuel pipe outer wall 360 and an engine fuel pipe inner wall 361. Source fuel pipe 384 may similarly include a source fuel pipe outer wall 385 and a source fuel pipe inner wall 386. In some embodiments, the respective outer walls and inner walls may represent two pipes of a pipe-in-pipe (PIP) assembly. The figure illustrates a cutaway view of engine fuel pipe 371, source fuel pipe 384, and enclosure 370 in order to depict the orientation of the respective outer walls and inner walls. Additionally, engine fuel pipe 371 may extend into gas ring 311. The figure illustrates a cutaway view of gas ring 311 to depict the orientation of engine fuel pipe outer wall 360 and engine fuel pipe inner wall 361 within gas ring 311. Engine fuel pipe outer wall 360 and engine fuel pipe inner wall 361 are cut at different lengths in the figure to further illustrate their orientation.

Engine fuel pipe outer wall 360 and engine fuel pipe inner wall 361 may be coaxial walls in which engine fuel pipe inner wall 361 is enclosed by engine fuel pipe outer wall 360, forming an engine fuel pipe outer channel 375 there between. In some embodiments, engine fuel pipe outer channel 375 may be an annulus. An engine fuel pipe inner channel 376 may be formed within engine fuel pipe inner wall 361. In preferred embodiments, engine fuel pipe inner wall 361 may be a conduit within engine fuel pipe 371 for delivering fuel 20.

Similarly, source fuel pipe outer wall 385 and source fuel pipe inner wall 386 may be coaxial walls in which source fuel pipe inner wall 386 is enclosed by source fuel pipe outer wall 385, forming a source fuel pipe outer channel 387 there between. In some embodiments, source fuel pipe outer channel 387 may be an annulus. A source fuel pipe inner channel 388 may be formed within source fuel pipe inner wall 386. In preferred embodiments, source fuel pipe inner wall 386 may be a conduit within source fuel pipe 384 for delivering fuel 20.

Source fuel pipe 384 may be connected to enclosure 370 at an inlet position 372, and engine fuel pipe 371 may be connected to enclosure 370 at outlet position 373. Inlet position 372 and outlet position 373 may each include an opening for the corresponding fuel pipe to fit through. Gas fuel system 350 may also include an inlet position 382 and an outlet position 383. An outer pipe flange 359 may be located outside each opening to seal the connection of the corresponding fuel pipe and enclosure 370. The outer pipe flange 359 located outside the opening at outlet position 373 may be referred to as a first outer pipe flange, and the outer pipe flange 359 located outside the opening at inlet position 372 may be referred to as a second outer pipe flange. Furthermore, welding may be performed around each outer pipe flange 359 to further ensure a proper seal as indicated by welds 358. In some embodiments, each outer pipe flange 359 may be a flange gasket.

As illustrated, engine fuel pipe outer wall 360 and source fuel pipe outer wall 385 may each terminate at an outer pipe flange 359. Outer pipe flange 359 may be located at each end of enclosure 370, and may be located outside of enclosure 370. In some embodiments, engine fuel pipe outer wall 360 and source fuel pipe outer wall 385 may extend into enclosure 370.

Additionally, engine fuel pipe inner wall 361 and source fuel pipe inner wall 386 may penetrate into enclosure 370. As shown, engine fuel pipe inner wall 361 and source fuel pipe inner wall 386 may extend past the opening of enclosure 370 at each respective end. Engine fuel pipe inner wall 361 and source fuel pipe inner wall 386 may each terminate at an inner pipe flange 366. Inner pipe flange 366 may be located at each end of gas fuel system 350. The inner pipe flange 366 located outside the outlet position of gas fuel system 383 may be referred to as a first inner pipe flange, and the inner pipe flange 366 located outside the inlet position of gas fuel system 382 may be referred to as a second inner pipe flange. A weld 358 may be welded between engine fuel pipe inner wall 361 and enclosure 370, and between source fuel pipe inner wall 386 and enclosure 370, to provide a seal. In some embodiments, welds 358 may be located on a surface of either outer pipe flange 359. Engine fuel pipe inner wall 361 and source fuel pipe inner wall 386 may connect with a component of gas fuel system 350 at inner pipe flange 366, such as a valve or a pipe. In some embodiments, each inner pipe flange 366 may be a flange gasket.

In preferred embodiments, enclosure 370 includes a ventilation system 345. Ventilation system 345 may include an air inlet 356, an air outlet 357, fans 354, and flame traps 353. Air inlet 356 may draw in air via fans 354 into the enclosure. The drawn in air may provide cooling for components of gas fuel system 350. In some embodiments, air inlet 356 draws in air from some location outside a vessel's hull such as deck 12. Air may exit enclosure through air outlet 357, also located outside the vessel's hull.

In addition, engine fuel pipe outer channel 375 and source fuel pipe outer channel 387 may include a positive pressure. In the case of a gas leak from engine fuel pipe inner wall 361 or source fuel pipe inner wall 386, the positive pressure within engine fuel pipe outer channel 375 or source fuel pipe outer channel 387 may force the gas leak out of enclosure 370. The positive pressure may be maintained with fans 354. Furthermore, gas clouds may also be prevented from entering into gas fuel system 350 due to enclosure 370.

Enclosure 370 may include at least one system in the event of a gas leak or a rapid combustion. For example, flame traps 353, located at the ends of air inlet 356 and air outlet 357, may protect against flare ups that may arise during the delivery of fuel to the combustion chamber if a gas leak within enclosure 370 develops. In addition, a gas detector 352 may be located within air outlet 357. Gas detector 352 may detect leaked gas or leaking gas inside enclosure 370 and signal to gas turbine control system 335 to shut off gas flow. In some embodiments, a gas fuel control system within gas turbine control system 335 may be directed to shut off gas flow. A fire damper 389 may be located within air inlet 356 and within air outlet 357. Fire damper 389 may be a mechanism that automatically shuts off ventilation air when a fire is detected. In some embodiments, fire damper 389 may shut the cross sectional area of pipe by pivoting a fire-resistant board, by steel shutters or blinds, or some other mechanism.

In the event of a rapid combustion within enclosure 370, the construction of enclosure 370 may be substantial enough to withstand any overpressure. Over pressure may be the shockwave due to a rapid combustion. Furthermore, any over pressure could be exhausted through air outlet 357 as a relief passage to the outside.

Engine fuel pipe outer channel 375 and source fuel pipe outer channel 387 may be injected with an inert gas such as nitrogen. Before operation of the gas turbine engine, all air within engine fuel pipe outer channel 375 and source fuel pipe outer channel 387 may be purged. The purging may occur through engine fuel pipe 371, source fuel pipe 384, and gas ring 311. A purge valve 369 located at a point along engine fuel pipe 371 may control the purging of air out of engine fuel pipe outer channel 375. A similar purge valve may be located at a point along source fuel pipe 384. After purging, nitrogen may be injected into engine fuel pipe outer channel 375 and source fuel pipe outer channel 387. An inert gas valve 368 may be located at a point along source fuel pipe 384. Inert gas valve 368 may control the flow of nitrogen into engine fuel pipe outer channel 375. A similar inert gas valve may be located at a point along engine fuel pipe 371. If a gas leak occurs from engine fuel pipe inner wall 361 or source fuel pipe inner wall 386, the gas can escape and interact with the nitrogen in engine fuel pipe outer channel 375 or source fuel pipe outer channel 387, respectively. It may be important that there is no air to interact with the escaped gas. The mixture of fuel and nitrogen, or any other inert gas, is not flammable. Furthermore, in the instance of a gas leak from engine fuel pipe inner wall 361 or source fuel pipe inner wall 386, the pressure within engine fuel pipe outer channel 375 or source fuel pipe outer channel 387 may increase, respectively. An inert gas pressure transducer 363, in some embodiments located on gas ring 311, may detect the increase in pressure within engine fuel pipe outer channel 375 or source fuel pipe outer channel 387. After detection of increased pressure, some safety measures may be taken. For example, an operator of the gas turbine engine may shut down gas turbine engine 100, shut the main gas valves to the engine room, and shut the gas shutoff valve in enclosure 370.

In some embodiments, an access panel 351 may be located on at least one side of gas fuel system 350. A plurality of bolts 374 may be configured to fasten access panel 351 to enclosure 370. Access panel 351 may be removed to allow access to gas fuel system 350 to perform maintenance or other service work.

Enclosure 370 may include mounting brackets 364 located in the bottom of enclosure 370. Mounting brackets 364 may secure enclosure 370 to a fixture such as the floor of a vessel or a gas turbine mounting structure by bolts or other types of fasteners.

In some embodiments, an electrical terminal box 355 may be connected to enclosure 370. Electric terminal box 355 may include wire terminals to connect to components within enclosure 370 such as sensors, solenoid valves, and control devices. Additionally, electrical terminal box 355 may be explosion proof. Electrical terminal box 355 may contain the wiring termination connections from functional components within enclosure 370. An electrical wiring harness 336 may connect gas turbine control system 335 and electrical terminal box 355. The control system wiring of gas turbine control system 335 may terminate at the terminals located in electrical terminal box 355.

A metering or throttle valve 346 may be located within gas fuel system 350. Throttle valve 346 may be part of a normal gas turbine engine control system. Furthermore, throttle valve 346 may be controlled by gas turbine control system 335 to increase or decrease the flow of gas to the gas turbine engine in order to increase or decrease the engine output power.

Gas processing system 377 may be located within enclosure 370. This may be important when combusting liquefied natural gas (LNG) as a fuel source. Gas processing system 377 may be configured to vaporize LNG. LNG may be vaporized to use as fuel. This vaporized fuel may include the portion of LNG that vaporizes in a fuel tank due to ambient heat, otherwise known as boil off gas (BOG). In applications where the amount of BOG may not be sufficient to operate gas turbine engine 100, fuel 20 may also include a portion of LNG from the fuel tank that is intentionally vaporized. The portion of the fuel that is intentionally vaporized will be referred to as FOG (Forced off Gas). FOG may be created by circulating LNG through a heat exchanger. Fuel 20 delivered to the gas turbine engine 100 may include both BOG and FOG, or in some instances just one of the two. Conduits, such as reservoirs or other collection devices of storing excess BOG, may deliver BOG formed in the fuel tank to gas turbine engine 100.

One or more of the above components (or their subcomponents) may be made from a base material that is stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance.

Superalloys may include materials such as alloy x, WASPALOY, RENE alloys, alloy 188, alloy 230, INCOLOY, INCONEL, MP98T, TMS alloys, and CMSX single crystal alloys.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries. Maritime transportation, in particular, has employed gas turbine engines for many years. Most of these gas turbine engines use diesel as the fuel source. However, due to changes in emission standards, there has been a trend towards lower emission fuel sources. Liquefied natural gas (LNG) has risen as an alternate fuel source for maritime transportation. Furthermore, gas turbine engines capable of using both types of fuel may have a significant advantage over engines that can only use one type of fuel.

A gas fuel delivery system 330 including a gas turbine engine 100 connected to a gas fuel system 350 may significantly reduce the weight of the gas turbine engine system 320. Traditionally, gas turbine engine packages include an enclosure surrounding the gas turbine engine, the fuel system, the power system, and other related systems. These traditional gas turbine engine package enclosures may provide protection from the environment but are generally very heavy. Installing such a package on smaller vessels, such as a high speed ferry, may affect the performance of the ferry. Furthermore, the traditional gas turbine package may not fit within the size limitations of the vessel hull of a high speed ferry or the like. In some instances, a dual fuel system may also add size limitations to the traditional gas turbine package. By limiting the enclosure 370 only around the gas fuel system 350, a significant weight reduction of the gas turbine engine package can be attained. In some embodiments, weight is reduced by 95% compared to traditional gas turbine engine packages. This may allow the gas turbine engine to create more thrust without upgrading the gas turbine engine.

During operation, gas leaks may occur in the fuel pipe of a gas fuel system. Gas leaks may result in damage to the gas fuel system and/or the gas turbine engine, such as fire or explosions. A number of systems may reduce the chances of such damage. As illustrated in FIG. 4, a ventilation system 345 including flame traps 353 to the outside may allow fire within engine fuel pipe 371, source fuel pipe 384, or enclosure 370 to escape. A gas detector 352 may detect the presence of a gas leak within ventilation system 345. Engine fuel pipe inner wall 361 may be surrounded by engine fuel pipe outer wall 360, forming an engine fuel pipe outer channel 375. Source fuel pipe inner wall 386 may be surrounded by source fuel pipe outer wall 385, forming a source fuel pipe outer channel 387. Engine fuel pipe outer channel 375 and source fuel pipe outer channel 387 may be filled with an inert gas which may protect against flammable gas leaks coming from engine fuel pipe inner wall 361 or source fuel pipe inner wall 386. Pressure transducers, such as inert gas pressure transducer 363, may also be utilized to detect increased pressure within either fuel pipe, which usually indicates a gas leak.

Other systems traditionally included in gas turbine engine packages enclosures may be transferred to the engine room of a vessel. For example, many engine rooms include a fire suppression system. It may be redundant to include a fire suppression system within a gas fuel system that is already housed within the engine room.

It should be emphasized that, although the disclosed gas turbine engine with gas fuel delivery system has been placed in a LNG carrier application such as a vessel, embodiments of the disclosed engine and gas fuel delivery system may be used in any application. For instance, an embodiment of the disclosure may be used in a reciprocating engine of a LNG carrying truck or locomotive, or may be used in a power plant application. Some applications may be limited by acoustic requirements wherein noise created by the gas turbine engine needs to be insulated.

In some embodiments, certain components or systems may satisfy code and rule requirements for use of the intended vessel or vehicle in the industry or field.

The preceding detailed description is merely exemplary in nature and is not intended to limit the invention or the application and uses of the invention. The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A gas turbine engine system comprising:
a gas turbine engine, the gas turbine engine including at least one injector;
a gas ring connected to the gas turbine engine, the gas ring including at least one injector lead connected to the at least one injector;
a gas fuel system;
an enclosure surrounding the gas fuel system, the enclosure including a ventilation system;
an engine fuel pipe connecting the gas fuel system to the gas ring, the engine fuel pipe including
an engine fuel pipe inner wall and an engine fuel pipe outer wall, the engine fuel pipe outer wall enclosing the engine fuel pipe inner wall forming an engine fuel pipe outer channel there between, and the engine fuel pipe inner wall in fluid communication with the gas fuel system and the gas ring; and
a source fuel pipe connected to the gas fuel system, the source fuel pipe including
a source fuel pipe inner wall and a source fuel pipe outer wall, the source fuel pipe outer wall enclosing the source fuel pipe inner wall forming a source fuel pipe outer channel there between, and the source fuel pipe connected to the gas fuel system, and the source fuel pipe inner wall in fluid communication with the gas fuel system.

2. The gas turbine engine system of claim 1, further including a first fuel source of liquefied natural gas connected to the source fuel pipe.

3. The gas turbine engine system of claim 2, further including a second fuel source of diesel connected to the source fuel pipe.

4. The gas turbine engine system of claim 1, wherein the engine fuel pipe outer channel and source fuel pipe outer channel are injected with nitrogen.

5. The gas turbine engine system of claim 1, wherein the enclosure further includes a gas processing system, a fire suppression system, and a gas detection system.

6. The gas turbine engine system of claim 1, further including an inert gas pressure transducer located on the gas ring.

7. A carrier including the gas turbine engine system of claim 1.

8. A gas fuel delivery system comprising:
a gas fuel system;
a gas ring;
an enclosure surrounding the gas fuel system, the enclosure including a ventilation system;
an engine fuel pipe connecting the gas fuel system to the gas ring, the engine fuel pipe including
a first fuel conduit and a first containment vessel, the first containment vessel enclosing the first fuel conduit, and the first fuel conduit in fluid communication with the gas fuel system and the gas ring;
a source fuel pipe connected to the gas fuel system, the source fuel pipe including a second fuel conduit and a second containment vessel, the second containment vessel enclosing the second fuel conduit; and the second fuel conduit in fluid communication with the gas fuel system;

9. The gas fuel delivery system of claim 8, wherein the first containment vessel and the first fuel conduit form a first outer conduit there between, and the second containment vessel and the second fuel conduit form a second outer conduit there between.

10. The gas fuel delivery system of claim 9, wherein the first outer conduit and the second outer conduit are annuluses.

11. The gas fuel delivery system of claim 10, wherein the first outer conduit and the second outer conduit are injected with an inert gas.

12. The gas fuel delivery system of claim 11, wherein the inert gas is nitrogen.

13. The gas fuel delivery system of claim 8, further including a first outer pipe flange, a first inner pipe flange, a second outer pipe flange, and a second inner pipe flange, wherein the first outer pipe flange seals the first containment vessel to the enclosure, the first inner pipe flange seals the first fuel conduit to the gas fuel system, the second outer pipe flange seals the second containment vessel to the enclosure, and the second inner pipe flange seals the second fuel conduit to the gas fuel system.

14. The gas fuel delivery system of claim 8, further including a first fuel source of liquefied natural gas connected to the source fuel pipe.

15. The gas fuel delivery system of claim 14, further including a second fuel source of diesel connected to the source fuel pipe.

16. The gas fuel delivery system of claim 8, wherein the enclosure further includes a gas processing system, a fire suppression system, and a gas detection system.

17. The gas fuel delivery system of claim 8, further including at least one flame trap within the ventilation system.

18. The gas fuel delivery system of claim 8, further including an inert gas pressure transducer located on the gas ring.

19. A vessel comprising:
an engine room and a fuel room, the fuel room including at least one fuel source;
a gas turbine engine located in the engine room, the gas turbine engine including at least one injector;
a gas ring connected to the gas turbine engine, the gas ring including at least one injector lead connected to the at least one injector;
a gas fuel system;
an enclosure surrounding the gas fuel system, the enclosure including a ventilation system with an air inlet and an air outlet to an atmosphere outside the vessel;
an engine fuel pipe connecting the gas fuel system to the gas ring, the engine fuel pipe including
an engine fuel pipe inner wall and an engine fuel pipe outer wall, the engine fuel pipe outer wall enclosing the engine fuel pipe inner wall forming an engine fuel pipe outer channel there between, and the engine fuel pipe inner wall in fluid communication with the gas fuel system and the gas ring; and
a source fuel pipe connecting the gas fuel system to the at least one fuel source, the source fuel pipe including
a source fuel pipe inner wall and a source fuel pipe outer wall, the source fuel pipe outer wall enclosing the source fuel pipe inner wall forming a source fuel pipe outer channel there between, and the source fuel pipe inner wall in fluid communication with the gas fuel system and the at least one fuel source/

20. The vessel of claim 19, further including a first fuel source of diesel and a second fuel source of liquefied natural gas.
